(19) United States
(12) Patent Application Publication
(10) Pub. No.: US 2012/0004748 A1
(43) Pub. Date: Jan. 5, 2012

(54) SYSTEM FOR SCORING GOLF TOURNAMENT

(76) Inventors: Scott Taffera, Edmonds, WA (US); Brian Remington, Seattle, WA (US)

(21) Appl. No.: 12/827,518

(22) Filed: Jun. 30, 2010

(51) Int. Cl. G06F 19/00

(52) U.S. Cl. 700/92

(57) ABSTRACT

It is an object of this invention to allow golfers/teams to provide tournament scorekeepers with dynamic information. It is another object of this invention to allow golfers/teams on the golf course to get contemporaneous or real time information on how others in the tournament are performing. It is another object of this invention to allow golfers/teams to check there performance on a particular course post tournament or play. It is another object of this invention to provide golfers/teams with handicaps for each course and instantaneously calculate a score for any hole given said handicap.

### CROSS-REFERENCES TO RELATED APPLICATIONS

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BRIEF SUMMARY OF THE INVENTION

Historians disagree about the origins of modern day golf. Most believe that the modern day game originated in Scotland around the 12^{th} century. However, some historians trace the sport back to the a Roman game called pagancia where players used sticks to hit stuffed leather balls. Other historians cite a Chinese game, known as chuiwan, as the inspiration for the modern day game. Chuiwan means striking a small ball. Whatever the origin, most golfers agree that the best part of golf is playing in a competition with some friends and a cooler full of beer.

The most basic type of golf play is match play and stroke play. In match play, at least two players or teams, play each hole as a separate contest. The team with the lower score wins the hole. The team that has won the most holes, wins the tournament. In stroke play, at least two players or teams compete on 18 holes and count the total number of strokes. The team with the lowest net scores, total score minus handicap, wins. Apart from these two basic types of play, other golf tournament formats exist such as Foursome, Four Ball, Texas Scramble, and Flag Tournaments.

In competition play, and in club play, individual and team scores are kept on score cards. In collegiate and PGA tournaments “live play” score is kept as runners are sent to the club house with hole scores or as golfers coming in from the course deliver hole scores to score keepers.

With the development of technology, more advanced digital score keepers have become available. These score keepers allow the user to keep his score. The more advanced score keepers may allow the user to keep his score and the score of his team mates. Some score keepers allow the user to keep track of his records for a particular golf coarse. These systems are good for what they purport to do—track individual or team scores. Nonetheless, they have drawbacks.

During competition play, the above mentioned golf scoring systems, do not allow individuals to send scores back to a club house so that real time data can be kept at hand and evaluated. Additionally, they do not allow players still out on the course to determine their standing in relation to the other teams playing. Also, competition data is not available to teams or players in an easily accessible format. Finally, carrying a score keeping device requires the player to carry the device in addition to his clubs, water, and other necessity.

### BRIEF DESCRIPTION OF THE INVENTION

It is therefore, an object of this invention to allow golfers/teams to provide tournament scorekeepers with dynamic information. It is another object of this invention to allow golfers/teams on the golf course to get contemporaneous or real time information on how others in the tournament are performing. It is another object of this invention to allow golfers/teams to check their performance on a particular course post tournament or during play. It is another object of this invention to provide golfers/teams with handicaps for each course and instantaneously calculate a score for any hole.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is a schematic showing the Golf Scoring System;

FIG. 2 is a schematic showing golf tournament information;

FIG. 3 is a schematic showing how a tournament is started;

FIG. 4 is a schematic showing how teams are registered for a tournament.

### DETAILED DESCRIPTION OF THE INVENTION

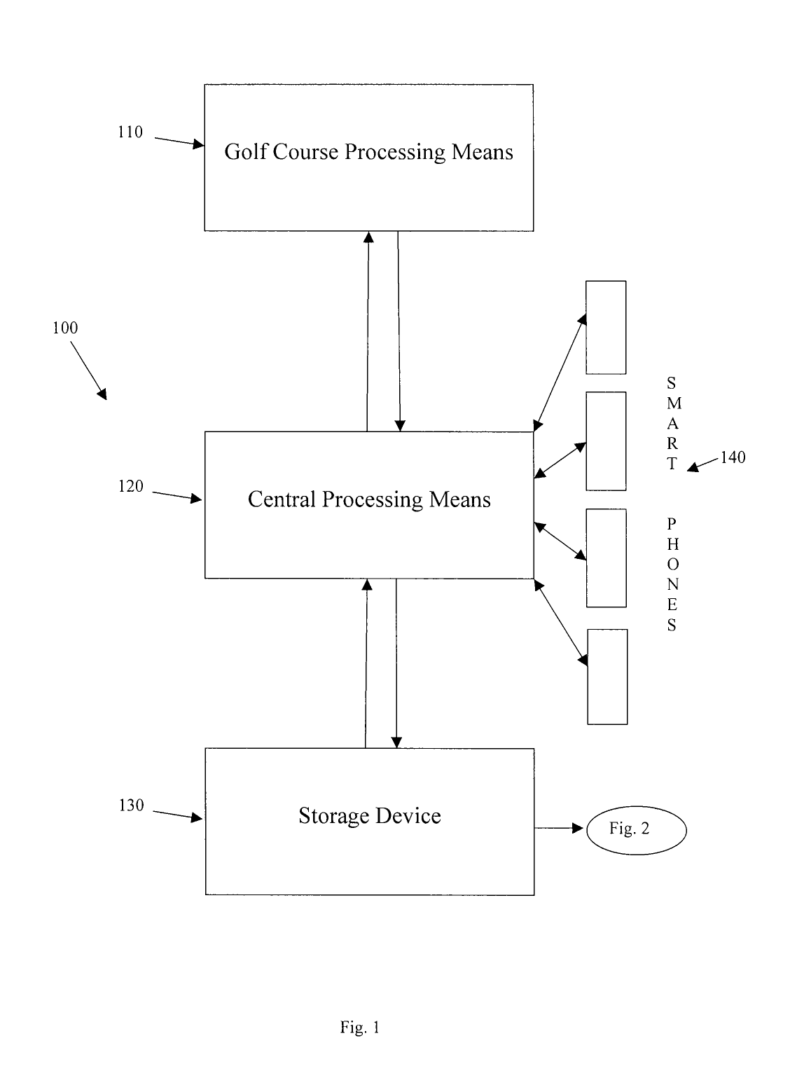

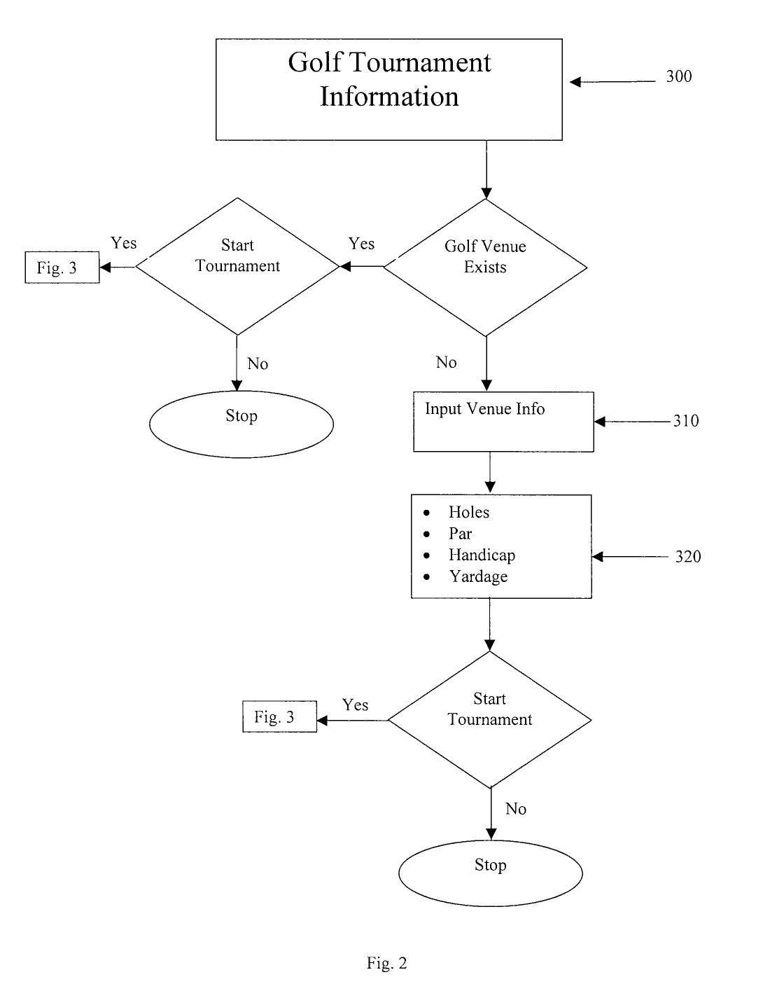

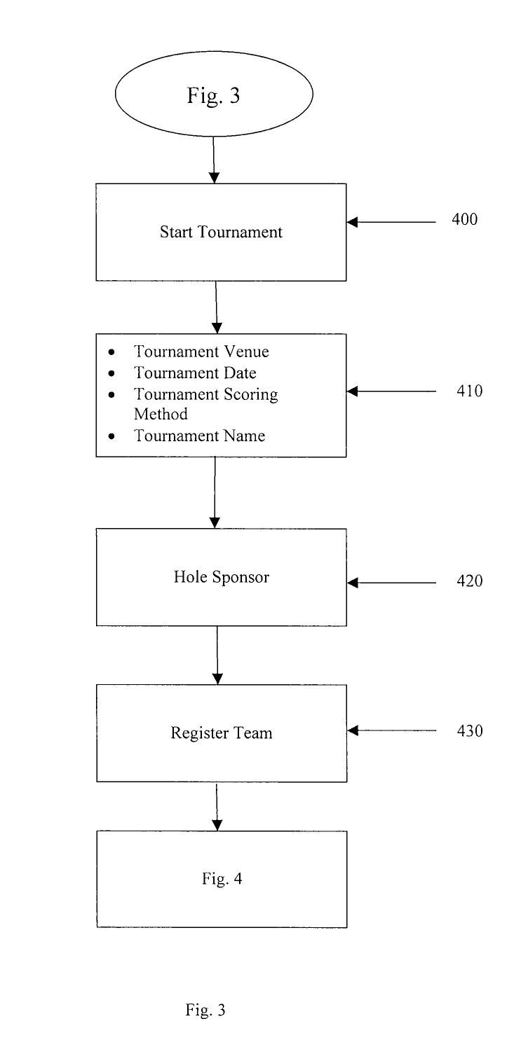

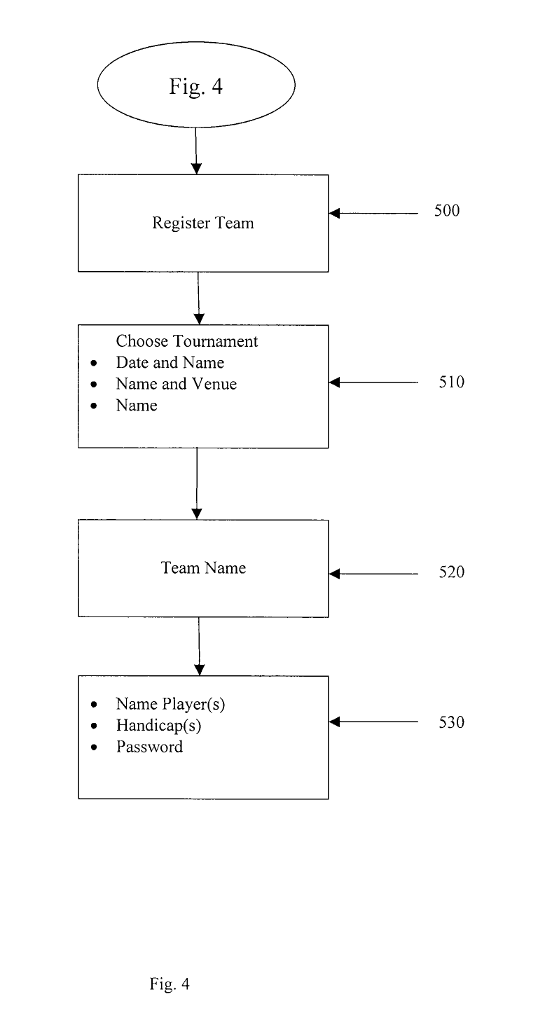

In the description of the invention above and in the detailed description of the invention, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally. Referring now in detail to the FIGS. 1 through 6, wherein the same numbers are used where applicable.

The invention is related to a system for scoring golf tournaments (hereinafter referred as “Golf Tournament System”) and is generally shown as 100 in FIG. 1. Although the Golf Tournament System is described using one golf tournament, as an example, it will be obvious to a person having ordinary skill in the art that the Golf Tournament System (100) can track multiple tournaments at any given time.

The Golf Tournament System (100) is comprised of a central processing means (120), a golf course processing means (110), and at least one smart phone (140). The central processing means (120) is comprised of at least one storage device (130).

The central processing means (120) accepts data relating to a golf tournament. The golf tournament data may be processed by the central processing means (120) or stowed in the at least one storage device (130) for later access and/or processing.

The central processing means (120) receives golf tournament information (300). The information can be entered by a smart phone (140) via wireless protocol technology or from the golf course processing means (110). Golf tournament information (300) consists of information regarding the tournament venue (310). Information relevant to the tournament venue (310) includes but, is not limited to: the number or name of each hole; the PAR for each hole; the handicap associated with each hole; and the yards to each hold (320). It will be obvious to a person having ordinary skill in the art that more information may be included about the venue. Once venue information (310) has been entered for a particular golf course, it can be saved in the storage device (130) for immediate use or it can be accessed at a later time.

To start a tournament (400) a venue (410), which has stowed in the storage device (130), must be chosen. This can be done from either the at least one smart phone (140) or the golf course processing means (110). Once the venue (410) has been chosen, at a minimum, the following information is needed to start a tournament (400): tournament name, tournament date, and tournament scoring method (410). It will be obvious to a person having ordinary skill in the art that other information may also be needed. If any of the holes in the tournament are sponsored, then hole sponsor (420) is entered. The Golf Scoring System (100) is now ready to register teams (500).

Each team must select the tournament it is playing. (510) The tournament can be selected by choosing a date and name of the tournament, name of the tournament and venue, or name of the tournament (510). Once a tournament is chosen, the tournament is given team information and a password is chosen (530). The password (530) assures that the raw data being sent to central processing means (120) cannot be altered by another team.

A team must consist of at least one player. A team name or identifier is input (520). For every team member, at least, the following must be entered: player name and handicap(s) (520). It will be obvious to a person having ordinary skill in the art that other information may also be required.

Once the central processing means (120) has registered a tournament (400) and a team (500), game play can begin. Teams or team members send encrypted real time raw scores to the central processing means (120) using at least one smart phone (140). The central processing means (120) will compute, using the raw scores, real time tournament scores and transmit the real time tournament scores, to the golf course processing means (110). The raw scores and real time scores are stowed in the storage device (130). A team (520) can request real time scores back or the central processing means (120) can push real time scores back to teams.

What is claimed is:

1. A system for managing golf tournament scoring comprising:
at least one mobile devices or smart phone having the ability to wirelessly access the internet from a golf course;
a central programmed data processing means having the ability to receive and transmit data to said mobile devices or smart phones or interact with the internet, or a combination thereof;
at least one storage device.

2. The system for managing golf tournament scoring of claim 1 where the central processing means receives information from the at least one smart phone or other processing device.

3. The system for managing golf tournament scoring of claim 1 where the central data processing means receives golf course information; said golf course information comprises at least the name of the golf course.

4. The system for managing golf tournament scoring of claim 3 where the central data processing means receives hole information; said hole information comprises at least: the name of at least one hole on the golf course; the handicap for said at least one hole; the PAR for said at least one hole; the yardage for said at least one hole.

5. The system for managing golf tournament scoring of claim 4 where the central processing means receives information related to a golf tournament; said golf tournament information comprises at least: tournament identification information and tournament scoring method; said information is stowed in the storage device.

6. The system for managing golf tournament scoring of claim 5 where the central processing means allows at least one team to register for at least one tournament; said team information is stored in the central processing means.

7. The system for managing golf tournament scoring of claim 6 where team raw scores, on a hole by hole basis, is accepted by a smart phone and transmitted to the central processing means via wireless protocol technology.

8. The system for managing golf tournament scoring of claim 7 where the central processing means processes team raw scores and transmits a processed score to the golf course processing means.

9. The system for managing golf tournament scoring of claim 8 where the processed score is stowed in the at least one storage device.

10. The system for managing golf tournament scoring of claim 8 where the processed data is transmitted to at least one smart phone via wireless protocol technology.

11. The system for managing golf tournament scoring of claim 8 where the processed data is requested by at least one smart phone via wireless protocol technology.

12. The system for managing golf tournament scoring of claim 8 where processed scores are requested for each team playing by at least one smart phone via wireless technology.
